(19) United States
(12) Patent Application Publication
(10) Pub. No.: US 2026/0299502 A1
(43) Pub. Date: Oct. 1, 2026

(54) POST-PROCESSING APPARATUS AND IMAGE FORMING APPARATUS

(71) Applicant: Konica Minolta, Inc., Tokyo (JP)

(72) Inventors: Hiroshi Yamaguchi, Tokyo (JP); Masayuki Watanabe, Tokyo (JP); Kenji Izumiya, Tokyo (JP); Hitoshi Asano, Aichi (JP); Hiroshi Oyama, Tokyo (JP); Akira Okamoto, Tokyo (JP); Shota Igo, Tokyo (JP)

(73) Assignee: Konica Minolta, Inc., Tokyo (JP)

(21) Appl. No.: 19/578,388

(22) Filed: Mar. 25, 2026

(30) Foreign Application Priority Data
Mar. 31, 2025 (JP) 2025-058417

(51) Int. Cl. G03G 15/00; B26D 7/18; B26D 1/08

(52) U.S. Cl. CPC G03G 15/6582; B26D 7/1854; G03G 15/6573; B26D 1/085; G03G 2215/00814

(57) ABSTRACT

Provided is a post-processing apparatus that includes: a cutter that cuts a sheet, which is to be conveyed, in a direction orthogonal to a conveyance direction to generate waste; and a sheet processor that is capable of processing the sheet to be conveyed and processes and deforms a region in the sheet, where the region become the waste after being cut by the cutter.

### CROSS REFERENCE TO RELATED APPLICATIONS

The entire disclosure of Japanese Patent Application No. 2025-58417, filed on Mar. 31, 2025, is incorporated herein by reference in its entirety.

### BACKGROUND

### Technological Field

The present invention relates to a post-processing apparatus and an image forming apparatus.

### Description of Related Art

In the related art, in an image forming apparatus, a post-processing apparatus is used which performs, on a sheet on which an image is formed by an image forming section, cutting processing of cutting an end portion of the sheet or dividing the sheet into a plurality of regions. The post-processing apparatus includes a cutter including an upper blade and a lower blade arranged above and below a sheet to be conveyed, and a waste box for accommodating cutting waste generated by cutting is installed below the cutter.

In such a post-processing apparatus, in order to smoothly collect cutting waste generated by cutting into a waste box, it has been considered to promote falling of the cutting waste.

For example, Japanese Patent Application Laid-Open No. 2006-205309 (hereinafter referred to as “PTL 1”) discloses a post-processing apparatus including: a vertical cover body on a side of a rubbing surface of an upper blade; and a horizontal cover body provided so as to protrude from the upper blade toward the vertical cover body. This post-processing apparatus pushes air in a space surrounded by the upper blade, the horizontal cover body, and the vertical cover body downward and promotes the falling of cutting waste by lowering the horizontal cover body together with the upper blade.

However, in particular, in a case where a sheet thickness of a sheet such as a thin sheet is thin or in a case where the size of cutting waste is small, simply blowing wind from above as in PTL 1 described above may cause generated cutting waste to stick to a cutting blade at the time of CD cutting when the generated cutting waste is electrostatically charged. It is possible to consider a case where the wind does not easily hit the cutting waste sticking to the cutting blade and the cutting waste does not easily fall. Such cutting waste may not fall normally, the cutting waste may stick to the cutter, may be finely cut at the time of the next cutting, and may be conveyed to downstream in the conveyance route at the time of sheet conveyance, and clogging of the sheet may occur, which may lead to an interruption of the operation.

### SUMMARY

An object of the present invention is to provide a post-processing apparatus and an image forming apparatus each capable of causing even a thin sheet or a small cutting waste to fall easily.

In order to achieve at least one of the above-mentioned objects, a post-processing apparatus reflecting one aspect of the present invention includes: a cutter that cuts a sheet, which is to be conveyed, in a direction orthogonal to a conveyance direction to generate waste; and a sheet processor that is capable of processing the sheet to be conveyed and processes and deforms a region in the sheet, where the region becomes the waste after being cut by the cutter.

An image forming apparatus reflecting one aspect of the present invention includes: the post-processing apparatus having the above-described configuration; and an image forming apparatus main body that forms an image on the sheet and ejects, to the post-processing apparatus, the sheet on which the image has been formed.

### BRIEF DESCRIPTION OF DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a configuration view of an image forming apparatus including a post-processing apparatus according to an embodiment of the present invention;

FIG. 2 is a block diagram illustrating the functional configuration of the image forming apparatus;

FIG. 3 is an enlarged diagram illustrating the configuration of a main part of a CD cutter;

FIG. 4 is a schematic configuration view of an upper blade indicating the position of an air blower in the CD cutter when the upper blade is viewed from an FD direction;

FIG. 5A is a view of a guillotine cutter and a falling route in a case where a leading end portion of a sheet is cut, and FIG. 5B is a view of a guillotine cutter and a falling route in a case where a rear end portion of the sheet is cut;

FIG. 6A, FIGS. 6B, and FIG. 6C are diagrams each of which illustrates an example of deformed cutting waste;

FIG. 7 is a diagram illustrating an example of a blade section of a sheet processor that forms the deformed cutting waste illustrated in FIG. 6A;

FIG. 8A, FIGS. 8B, and FIG. 8C are diagrams illustrating examples of cutting waste to which wind is blown;

FIG. 9 is a plan view of an exemplary product in which cutting waste is generated;

FIG. 10 is a plan view of the exemplary product in FIG. 9 in a state in which a small piece that is cutting waste is generated;

FIG. 11 is a diagram illustrating a state in which cutting waste is generated by a cutter in the image forming apparatus;

FIG. 12 is a plan view of an exemplary product in which cutting waste is generated;

FIG. 13 is a plan view of an exemplary sheet including a product in which cutting waste is generated; and

FIG. 14 is a plan view of a cutting waste portion and a product in the sheet illustrated in FIG. 13.

### DETAILED DESCRIPTION OF EMBODIMENTS

Hereinafter, one or more embodiments of the present invention will be described with reference to the drawings. However, the scope of the invention is not limited to the disclosed embodiments.

Hereinafter, an embodiment of the present invention will be described in detail with reference to the accompanying drawings.

### Configuration of Image Forming Apparatus 1

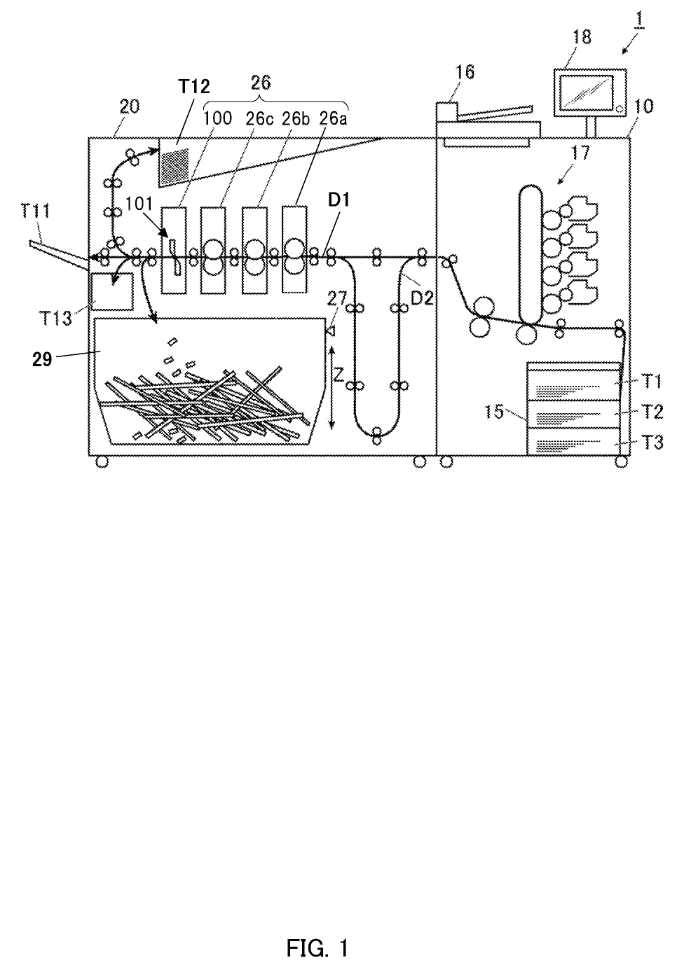

FIG. 1 is a configuration view of an image forming apparatus 1 in an embodiment of the present invention. The image forming apparatus 1 is configured to include: an image forming apparatus main body 10 that forms an image on a sheet; and a post-processing apparatus 20 that performs cutting processing on the sheet on which the image has been formed by the image forming apparatus main body 10.

Note that, the image forming apparatus 1 in the present invention may encompass both a case where the image forming apparatus main body 10 and the post-processing apparatus 20 which are separately configured are coupled to each other and a case where the image forming apparatus main body 10 and the post-processing apparatus 20 are integrally configured.

### Image Forming Apparatus Main Body 10

The image forming apparatus main body 10 forms an image on a sheet according to an operation instruction inputted from an operation display section 18 or an image forming instruction received from a personal computer (PC) or the like via a communication network. The image forming apparatus main body 10 conveys a sheet after image formation to the post-processing apparatus 20.

The image forming apparatus main body 10 includes a sheet feed section 15, an image reading section 16, an image forming section 17, the operation display section 18, and the like.

The sheet feed section 15 includes a plurality of sheet feed trays T1 to T3 capable of accommodating sheets different in size, type (sheet type), basis weight, and the like, and supplies a sheet accommodated in a specified one of the sheet feed trays T1 to T3 to the image forming section 17.

The image reading section 16 reads a document to generate image data. Specifically, the image reading section 16 reads reflected light, which is emitted from a light source and reflected by a document, by using a charge coupled device (CCD) image sensor or the like.

The image forming section 17 forms an image on a sheet. The image forming section 17 charges a photoreceptor with a charging section and exposes and scans the photoreceptor with a laser beam emitted from an exposure section based on image data to form an electrostatic latent image. The electrostatic latent image is developed with toner by a developing section, the developed toner image is transferred onto the sheet by a transfer section, and the toner image is fixed onto the sheet by a fixing section, thereby forming an image on the sheet.

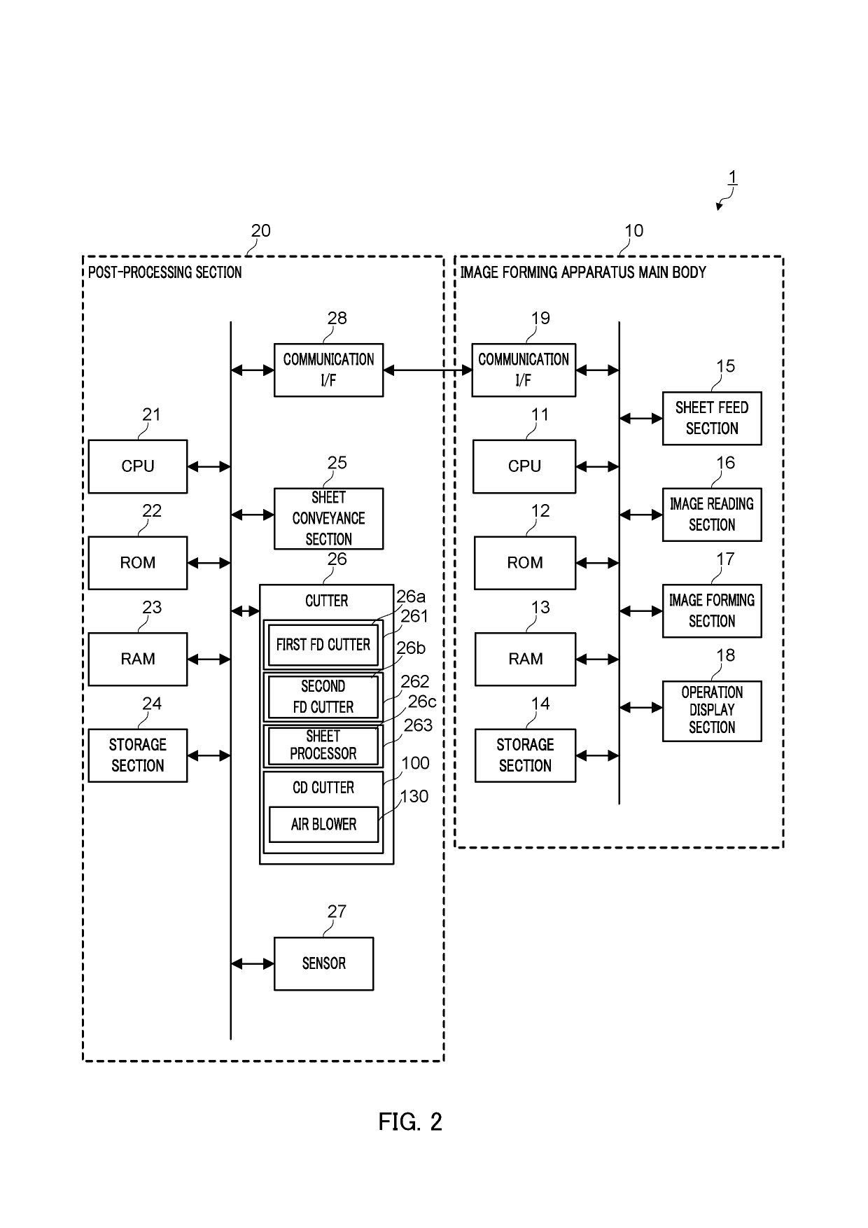

The operation display section 18 is constituted by a liquid crystal display (LCD), and includes: a display section that displays various screens; and an operation section constituted by a touch screen stacked on the display section and various keys. The operation display section 18 outputs an operation signal inputted by a touch operation or a key operation to a central processing unit (CPU) 11 (see FIG. 2).

### Post-Processing Apparatus 20

The post-processing apparatus 20 functions as a cutting machine that performs cutting processing on a sheet. The post-processing apparatus 20 performs cutting processing on a sheet, which has been conveyed in from the image forming apparatus main body 10, as necessary, and discharges a product created by the cutting processing to a sheet ejection tray T11 or T12 or a card tray T13.

The post-processing apparatus 20 includes a conveyance path D1, a cutter 26, a sensor 27, a waste box 29, and the like. The conveyance path D1 is provided with an elongated sheet conveyance path D2 that branches from the conveyance path D1 and merges therewith downstream. The elongated sheet conveyance path D2 is used as a buffer when an elongated sheet is conveyed.

The cutter 26 performs cutting processing on a sheet to be conveyed, where various types of processing are performed on the sheet and the sheet is cut.

The cutter 26 processes and cuts the sheet according to a cutting mode, which will be described later, by a CPU 21 or the like. The cutter 26 includes modules (26a, 26b, and 26c) each of which performs predetermined processing on a sheet, and a CD cutter 100.

The modules (26a, 26b, and 26c) are attachable to a plurality of slots 261 to 263 (see FIG. 2) provided at a plurality of positions in the conveyance path D1 for a sheet, respectively.

The plurality of slots 261 to 263 to which the modules (26a, 26b, and 26c) are attached performs processing, which differs for each module, on a sheet. The modules (26a, 26b, and 26c) attached to the slots 261 to 263 are connected to and driven by a drive source whose driving is controlled by a control section including the CPU 21.

The modules that are attached to the slots 261 to 263 are a first FD cutter 26a, a second FD cutter 26b, and a sheet processor 26c. Note that, the modules that are attached to the slots 261 to 263 can be appropriately changed to modules having functions corresponding to processing on sheets, and conveyance slots only for conveyance may also be attached. That is, each of the first FD cutter 26a, the second FD cutter 26b, and the sheet processor 26c is configured to be detachable from and attachable to the main body of the post-processing apparatus 20, and the arrangement order of the modules is also replaceable. In addition, the CD cutter 100 may also be modularized and configured to be detachable from and attachable to the main body of the post-processing apparatus 20.

The first FD cutter 26a and the second FD cutter 26b are cutting machines (slitters) that cut a sheet along the conveyance direction of the sheet (feed direction). The first FD cutter 26a includes a slitter that cuts both end portions (far side and near side) separated from each other in a direction orthogonal to the conveyance direction of the sheet. The second FD cutter 26b includes a bleed off slitter which cuts a margin between sheets (products) adjacent to each other in the direction orthogonal to the conveyance direction of the sheet. Note that, details of the first FD cutter 26a and the second FD cutter 26b will be described later.

The sheet processor 26c performs processing such as perforation, creasing, and notching (cutting) on a sheet to be conveyed. In particular, the sheet processor 26c has a sheet deforming function of processing, when a product is formed by cutting a sheet to be conveyed, a region on the sheet, where the region is cut by the CD cutter 100 and becomes cutting waste (hereinafter, this region will be referred to as a “waste region”), to deform the waste region in the sheet. Details of the sheet processor 26c will be described later.

The CD cutter 100 includes a guillotine cutter 101 that cuts the sheet along a direction (cross direction) orthogonal to the conveyance direction.

Whether to use the first FD cutter 26a, the second FD cutter 26b, the sheet processor 26c, and the CD cutter 100 is determined according to the cutting mode. In addition, with respect to the first FD cutter 26a, the second FD cutter 26b, and the sheet processor 26c, the modules for processing are appropriately changed according to the cutting mode. In the present embodiment, the function of the sheet processor 26c is an essential function, and in a case where the sheet processor 26c is not used, the CD cutter 100 is configured to execute the sheet deforming function of the sheet processor 26c. The cutting mode is a cutting control mode determined based on the cutting type, the side, thickness (sheet thickness), type, and basis weight of a sheet, and the like for processing the sheet to finally form a product.

The sensor 27 detects cutting waste at a predetermined position in a depth direction in the waste box 29 (the Z direction illustrated in FIG. 1), and outputs a detection result to the CPU 21 (see FIG. 2). That is, the sensor 27 performs detection that a certain amount of cutting waste has been loaded in the waste box 29.

The waste box 29 is installed below the cutter 26, and accommodates cutting waste generated by the cutting operation of the cutter 26 and falling from the cutter 26. The user opens a door of the post-processing apparatus 20, takes out the waste box 29, and discards the cutting waste in the waste box 29.

FIG. 2 is a block diagram illustrating the functional configuration of the image forming apparatus 1.

The image forming apparatus main body 10 includes a CPU 11, a read only memory (ROM) 12, a random access memory (RAM) 13, a storage section 14, the sheet feed section 15, the image reading section 16, the image forming section 17, the operation display section 18, a communication interface (I/F) 19, and the like.

The CPU 11 reads a program accommodated in the ROM 12, develops the program in the RAM 13, and cooperates with the developed program to control the operation of each section of the image forming apparatus body 10. The ROM 12 is constituted by a non-volatile memory or the like, and stores a system program, as well as various processing programs, various data, and the like which are executable on the system program.

The CPU 11, the ROM 12, the RAM 13, the storage section 14, and the like constitute a control section and control image formation processing on a sheet. The control section controls the cutter 26 via the control section of the post-processing apparatus 20 according to the cutting mode to generate a sheet as a predetermined product. In particular, the control section controls the sheet processor 26c in a normal mode in which a perforation, a crease, a notch, or the like is formed, or controls the sheet processor 26c in a sheet deformation mode in which the sheet deforming function is executed.

The RAM 13 is constituted by a volatile semiconductor memory or the like, and forms a work area for temporarily storing programs read from the ROM 12, input or output data, parameters, and the like in various types of processing executed by the CPU 11.

The storage section 14 is constituted by a hard disk drive (HDD), a non-volatile semiconductor memory, or the like, and stores various types of data.

The communication I/F 19 is constituted by a network interface card (NIC), a modem, or the like, and transmits and receives data to and from the post-processing apparatus 20 or a PC.

The post-processing apparatus 20 includes the CPU 21, a ROM 22, a RAM 23, a storage section 24, a sheet conveyance section 25, the cutter 26, the sensor 27, a communication I/F 28, and the like.

The CPU 21, the ROM 22, and the RAM 23 are the same as the CPU 11, the ROM 12, and the RAM 13 except that the control target of the CPU 21 is the post-processing apparatus 20. The CPU 21, the ROM 22, the RAM 23, the storage section 24, and the like constitute a control section, control the cutter 26 according to the cutting mode to generate a sheet as a predetermined product.

The storage section 24 is constituted by an HDD, a non-volatile semiconductor memory, or the like, and stores various types of data.

The sheet conveyance section 25 conveys a sheet, which has been conveyed in from the image forming apparatus body 10, until the sheet is discharged to the sheet ejection tray T11 or T12 or the card tray T13. The communication I/F 28 is constituted by an NIC, a modem, or the like, and transmits and receives data to and from the image forming apparatus 10.

### Cutter 26

### CD Cutter 100

Here, a detailed configuration of the CD cutter 100 will be described.

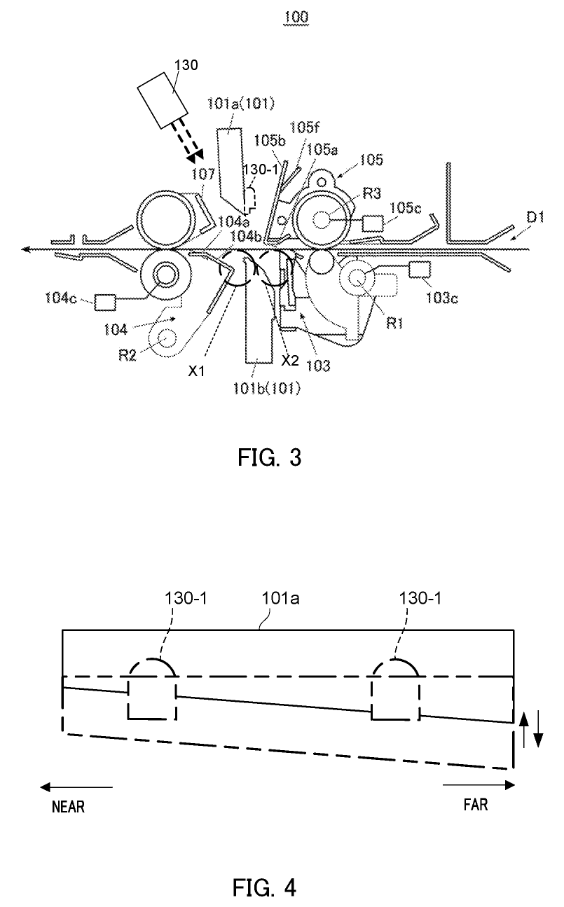

FIG. 3 is an enlarged diagram illustrating the configuration of a main part of the CD cutter 100, and FIG. 4 is a schematic configuration view of an upper blade indicating the position of an air blower in the CD cutter.

As illustrated in FIG. 3, the CD cutter 100 includes a guillotine cutter 101, an upstream guide section 103, a downstream guide section 104, a waste guide section 105, a conveyance guide 107, and an air blower 130.

The guillotine cutter 101 includes an upper blade 101a provided above the conveyance path D1 so as to extend along the CD direction of the conveyance path, and a lower blade 101b provided below the conveyance path D1 so as to extend along the CD direction of the conveyance path. Note that, the CD direction of the conveyance path D1 is a direction orthogonal to the conveyance direction (FD direction).

The upper blade 101a moves in the downward direction with respect to the lower blade 101b that is fixed, so that the guillotine cutter 101 cuts the sheet at a cutting position held between the blades of the upper blade 101a and the lower blade 101b in the conveyance path D1.

The air blower 130 blows wind from above to the vicinity of the cutting position of the sheet by the upper blade 101a and the lower blade 101b to promote the falling of cutting waste generated by cutting. The air blower 130 includes a fan that blows wind from above toward the cutting position of the CD cutter. The fan is of a type having a high static pressure, and thus, wind can be blown more effectively.

The air blower 130 is configured by, for example, disposing the fan so that the fan blows wind from above the cutting position of the sheet toward the cutting position with the lower blade 101b portion and toward a side surface of the upper blade 101a. The air blower 130 blows wind at a timing when the upper blade 101a descends and cuts the sheet with the lower blade 101b. Thus, the generated cutting waste can be configured to fall more easily. In addition, the air blower 130 may also be provided adjacent to the upper blade 101a in the FD direction, as in air blowers 130-1.

In the air blower 130, for example, the fan blows wind in a direction perpendicular to the upper surface of the sheet. The fan is of a type having a high static pressure and is capable of blowing wind more effectively. As in the air blowers 130-1 illustrated in FIG. 4, for example, a plurality of the air blowers 130 may be disposed at a plurality of positions close to or adjacent to the upper blade 101a in the FD direction and separated from each other at a predetermined interval in the CD direction.

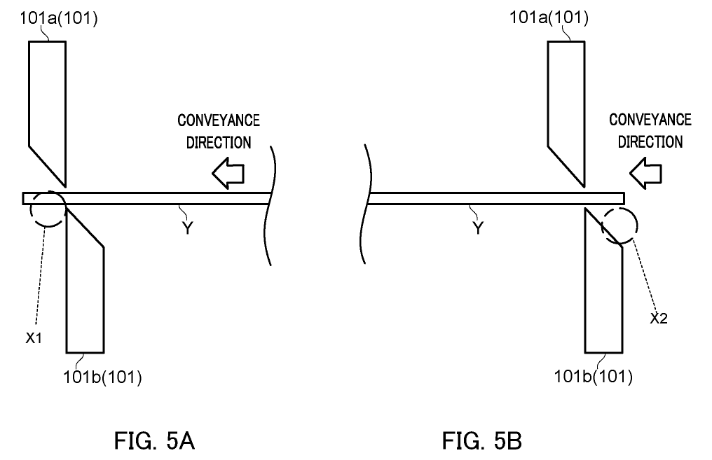

FIGS. 5A and 5B are views of falling routes of cutting waste when the both end portions of a sheet in the conveyance direction are cut. FIG. 5A is a view of a guillotine cutter and a falling route in a case where a leading end portion of a sheet is cut, and FIG. 5B is a view of a guillotine cutter of a CD cutter for a rear end portion of the sheet and a falling route.

The CD cutter 100 cuts a sheet to be conveyed by shearing a predetermined region in the sheet with the upper blade 101a and the lower blade 101b from above and below, thereby generating cutting waste. Note that, the cutting waste referred to herein is a small piece or is thin and has a shape that is likely to cause the cutting waste to stick to the upper blade 101a or the lower blade 101b after cutting due to static electricity generated by conveyance. When the waste generated by cutting is elongated waste or relatively heavy waste, the waste falls smoothly by its own weight without sticking to the upper blade 101a, the lower blade 101b, or the like.

As illustrated in FIG. 5A, cutting waste generated by cutting passes through a route X1 and falls downward when the cutting waste is generated on the side of the leading end of the sheet, whereas, as illustrated in FIG. 5B, cutting waste generated by cutting passes through a route X2 and falls downward when the cutting waste is generated on the side of the rear end of the sheet. Since wind is blown to a cutting portion by the air blower 130 during cutting, the generated cutting waste is likely to fall downward.

FIG. 3 will be referred to again. The upstream guide section 103 is provided on the upstream side of the lower blade 101b in the FD direction, and the downstream guide section 104 is provided on the downstream side of the lower blade 101b in the FD direction.

The upstream guide section 103 is an elongated member that is long in the CD direction orthogonal to the conveyance direction, and is configured to be swung by a variable mechanism 103c so as to be changeable between a posture of conveying the sheet and a posture of forming a falling route through which cutting waste is allowed to fall. For example, the variable mechanism 103c includes a rotation shaft R1 that pivotally supports the upstream guide section 103, a motor that rotates the rotation shaft R1, and the like, and the variable mechanism 103c is controlled by the CPU 21 to swing the upstream guide section 103.

The downstream guide section 104 is an elongated member that includes a conveyance guide section 104a and a falling route forming section 104b and extends in the CD direction. The downstream guide section 104 includes a variable mechanism 104c that swings the downstream guide section 104 so that the downstream guide section 104 is at a position at which one of the conveyance guide section 104a and the falling route forming portion 104b functions.

The downstream guide section 104 is provided below the conveyance path D1 on the downstream side of the lower blade 101b in the FD direction so that the longitudinal direction thereof is along the CD direction.

The downstream guide section 104 is configured to be swingable around a rotation shaft R2. The downstream guide section 104 is located and functions at any one of a “conveyance guide position” (the position illustrated in FIG. 3) at which the downstream guide section 104 functions as a conveyance guide for a sheet; a “route forming position” at which the downstream guide section 104 forms a conveyance route (falling route) for cutting waste; and a “retraction position” at which the downstream guide section 104 avoids the operation of the upper blade 101a. Note that, the “conveyance guide position” is a position at which the conveyance guide section 104a of the downstream guide section 104 is disposed parallel to and along the conveyance path D1. The “route forming position” is a position at which a space serving as a conveyance route for cutting waste is formed in the conveyance path D1 on the downstream side of the lower blade 101b by the downstream guide section 104 rotating clockwise by a predetermined angle from the “conveyance guide position”.

In addition, the “retraction position” is a position at which the rotation angle of the downstream guide section 104 is smaller than that at the “route forming position” and the conveyance guide section 104a is retracted from the conveyance path D1. The variable mechanism 104c includes, for example, the rotation shaft R2 that pivotally supports the downstream guide section 104, a motor that rotates the rotation shaft R2, and the like, and swings the downstream guide section 104 under the control of the CPU 21.

The waste guide section 105 is provided at a position facing the upstream guide section 103 with the conveyance path D1 interposed therebetween.

The waste guide section 105 is an elongated member including a conveyance guide surface 105a and a waste guide surface 105b. The waste guide section 105 includes: a variable mechanism 105a that swings the waste guide section 105 so that the waste guide section 105 is at a position at which one of the conveyance guide surface 105b and the waste guide surface 105c functions; and an air blowing guide surface 105f that guides wind from the air blower 130.

The waste guide section 105 is installed above the conveyance path D1 on the upstream side of the upper blade 101a in the FD direction so that the longitudinal direction thereof is along the CD direction. The waste guide section 105 is disposed at a position substantially facing the upstream guide section 103.

The waste guide section 105 swings around a rotation shaft R3 and can be displaced to any one of a “conveyance guide position”, a “waste guide position”, and a “jam processing position”.

The “conveyance guide position” is a position at which the conveyance guide surface 105a of the waste guide section 105 is disposed parallel to and along the conveyance path D1 so as to function as a conveyance guide for a sheet. The “waste guide position” is a position at which the waste guide section 105 rotates counterclockwise by a predetermined angle from the “conveyance guide position” to form a guard above the lower blade 101b where the guard covers the lower blade 101b in order to prevent cutting waste from flying upward. The “jam processing position” is a position at which the waste guide section 105 rotates clockwise by a predetermined angle from the "conveyance guide position" to form a space for jam processing on the upstream side of the lower blade 101b in order to enable jam processing when a jam occurs.

The variable mechanism 105c includes the rotation shaft R3 that pivotally supports the waste guide section 105, a motor that rotates the rotation shaft R3, and the like. The variable mechanism 105c is controlled by the CPU 21, and swings the waste guide section 105 as described above.

Note that, the air blowing guide surface 105f is formed by bending an upper portion of the waste guide surface 105b by a predetermined angle. When the position of the waste guide section 105 is switched to the “waste guide position”, the air blowing guide surface 105f is substantially parallel to a rubbing surface of the upper blade 101a against the lower blade 101b and guides the wind sent from the air blower 130 downward.

The conveyance guide 107 is fixed at a position substantially facing the downstream guide section 104 with the conveyance path D1 interposed therebetween.

Next, the modules (26a, 26b, and 26c) that are attached to the respective slits 261 to 263 of the cutter 26 will be described in detail.

### First FD Cutter 26a and Second FD Cutter 26b

The first FD cutter 26a, the second FD cutter 26b, and the sheet processor 26c are modules which are provided to be detachable from and attachable to the slots 261 to 263, and exhibit their function by being appropriately attached to any of the slots 261 to 263. Note that, the first FD cutter 26a, the second FD cutter 26b, and the sheet processor 26c are driven and controlled via the CPU 21 according to the control mode.

The first FD cutter 26a and the second FD cutter 26b each include a cutter capable of performing cutting in the conveyance direction, that is, in the FD direction, are disposed with the blade directed in the FD direction, and cut the sheet, which is conveyed, along the FD direction. The cutter may be configured in any manner as long as the cutter has such a function of performing cutting in the FD direction.

For example, as an example in a case where a sheet Y1 (see FIG. 9) is cut, the first FD cutter 26a includes a pair of cutters at positions that allow the both end portions of the sheet Y to be cut, respectively.

The second FD cutter 26b includes a cutter that performs cutting (bleed slitting) that generates waste which has a width in the CD direction and extends in the FD direction in the sheet. A pair of cutters is provided to be separated from each other in the CD direction so as to have a predetermined width. For example, in a case where a plurality of elongated cutting wastes is formed by forming two slits having a predetermined width in a central portion of the sheet, the second FD cutter 26b is preferably configured to include a set of cutters that form the respective slits. According to this configuration, when a sheet is conveyed to the second FD cutter 26b, the sheet can be cut without stopping the conveyance of the sheet.

### Sheet Processor 26c

The sheet processor 26c is a module which has a function of processing a sheet and has a function of deforming a processed portion by using the foregoing function of processing a sheet.

The sheet processor 26c has, for example, one function of a perforation forming function, a crease forming function, and a notch forming function as a sheet processing function, and uses the above function to process and deform a region, which becomes cutting waste, to deform the generated cutting waste itself. The sheet processing part 26c deforms cutting waste itself to cause the cutting waste to easily fall.

For example, a perforation forming module that forms a perforation in a sheet, a crease forming module that forms a fold in a sheet, or a notch forming (cutting) module that forms a notch portion is applied to the sheet processor 26c. Note that, the sheet processor 26c may be a module having two or more functions of perforation formation, crease formation, and notch formation as sheet processing functions.

When the sheet processor 26c is the perforation forming module, a perforation is formed at a predetermined position in the sheet in the CD direction or in the FD direction. When the sheet processor 26c is the crease forming module, a crease is formed at a predetermined position in the sheet in the CD direction or in the FD direction. In addition, when the sheet processor 26c is the notch forming (cutting) module, a notch is formed at a predetermined position in the sheet in the CD direction or in the FD direction, or the sheet is cut in the CD direction or in the FD direction.

The sheet processor 26c is attachable to any of the slots 261, 262, and 263 and exhibits its function when attached thereto, but is attached to one of the slots 261 to 263 before cutting waste is generated by the CD cutter 100 in the present embodiment.

The sheet processor 26c is driven and controlled by the control section, and in a case where the sheet processor 26c is driven in the sheet deformation mode, the sheet processor 26c processes a region, which becomes cutting waste, in a sheet to generate deformed cutting waste.

Cutting waste KR deformed by the sheet processor 26c is less likely to stick to the upper blade 101a due to the deformation, and even in a case where the cutting waste KR sticks to the upper blade 101a, the cutting waste KR receives wind and is more likely to fall.

In a case where the basis weight or the sheet thickness of a sheet is smaller than a predetermined value, the sheet processor 26c processes a region, which becomes cutting waste, in the sheet. The predetermined value of the basis weight of the sheet is a value that defines the basis weight of the sheet so that the cutting waste is smaller than a falling route when the cutting waste falls and the cutting waste more easily falls through the falling route, and the value represents that the size of the sheet before the processing is too small and it is difficult for the cutting waste to pass through the falling route. The predetermined value of the sheet thickness of the sheet refers to a thickness of the sheet where the weight of the cutting waste does not allow the cutting waste to stick to the upper blade 101a even when the cutting waste is electrostatically charged, and refers to a thickness of the sheet where the sheet does not stick to the upper blade 101a even when the sheet is charged.

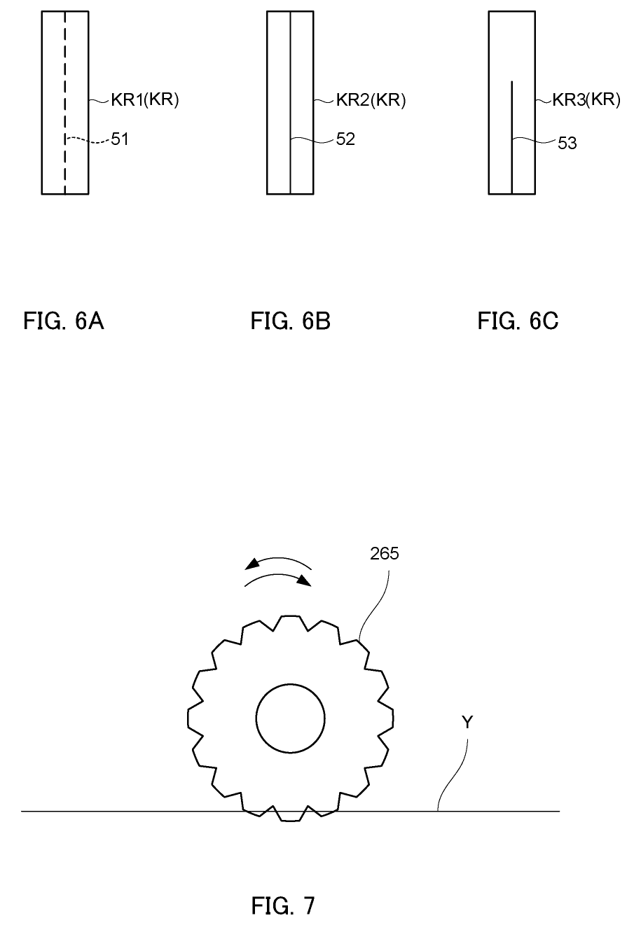

FIG. 6A, FIGS. 6B, and FIG. 6C are diagrams each of which illustrates an example of deformed cutting waste, and FIG. 7 is a diagram illustrating an example of a blade section of a sheet processor that forms the deformed cutting waste illustrated in FIG. 6A.

FIG. 6A illustrates cutting waste KR1 in which a perforation 51 is formed, FIG. 6B illustrates cutting waste KR2 in which a fold (crease) 52 is formed, and FIG. 6C illustrates cutting waste KR3 in which a notch portion 53 is formed.

For example, in a case where the sheet processor 26c forms the perforation 51 in a cutting waste region in a sheet (see the cutting waste KR1 in FIG. 6A), the perforation forming module is applied to the sheet processor 26c.

For example, in a case where the sheet processor 26c forms the fold 52 in a cutting waste region in a sheet (see the cutting waste KR2 in FIG. 6B), the crease forming module is applied to the sheet processor 26c. In addition, for example, in a case where the sheet processor 26c forms the notch portion 53 (see the cutting waste KR3 in FIG. 6C), the notch forming module or the like is applied to the sheet processor 26c.

When the sheet processor 26c is the perforation forming module, a perforation is formed in a cutting waste region in a sheet in the CD direction or in the FD direction. When the sheet processor 26c is the crease forming module, a crease is formed in a cutting waste region in a sheet in the CD direction or in the FD direction. Each of the perforation 51, the fold 52, and the notch portion 53 is processed so as to pass through the center of a region, which becomes one the cutting wastes KR1 to KR3, in the sheet, thereby deforming the sheet.

Each of the perforation 51, the fold 52, and the notch portion 53 is processed and formed so as to pass through the center of a region, which becomes one of the cutting wastes KR1 to KR3, in the FD direction and extend in the CD direction .

For example, the sheet processor 26c includes a rotary blade 265 which, in a case where the sheet processor 26c is the perforation forming module, rotates in the CD direction and in which perforation forming teeth are arranged at a predetermined interval on the outer periphery thereof as illustrated in FIG. 7.

The rotary blade 265 includes a rotation shaft extending in the conveyance direction, and can therefore form the perforation 51 in the sheet in the CD direction. At this time, in a case where the cutting waste is longer in the CD direction than in the FD direction, the rotary blade 265 can form a plurality of the perforations 51 at a plurality of locations of cutting waste regions in an appropriate sheet only by being moved in the CD direction.

In addition, the sheet processor 26c includes corner portions which, in a case where the sheet processor 26c is the crease forming module including a crease forming section, extending upward and downward in the CD direction, and the sheet processor 26c forms a fold in a sheet by holding the sheet between the corner portions and pressing the sheet. In addition, in a case where the sheet processor 26c is the notch forming module provided with a cutter, the sheet processor 26c forms a notch portion as appropriate in a cutting waste region in a sheet.

It is assumed that the processed portion such as the perforation 51, the fold 52, and the notch portion 53 is formed, for example, in a region, which becomes cutting waste, in a sheet in the CD direction. In this case, when a sheet is conveyed to a position at which the sheet processor 26c can process the sheet, a plurality of processed portions can be formed at once in a plurality of regions simply by positioning the rotary blade 265 at the center of a region in the sheet in the FD direction and moving the rotary blade 265 in the CD direction. Thus, processed portions can be efficiently formed in a region.

Note that, although it has been described that these processed portions are formed in a region, which becomes cutting waste, in a sheet in the CD direction, the direction in which processed portions are formed may be the FD direction. In the case of the FD direction, deformation processing that is processing of forming respective processed portions can be performed on regions disposed in the FD direction without stopping the conveyance of the sheet, and cutting processing can be efficiently performed.

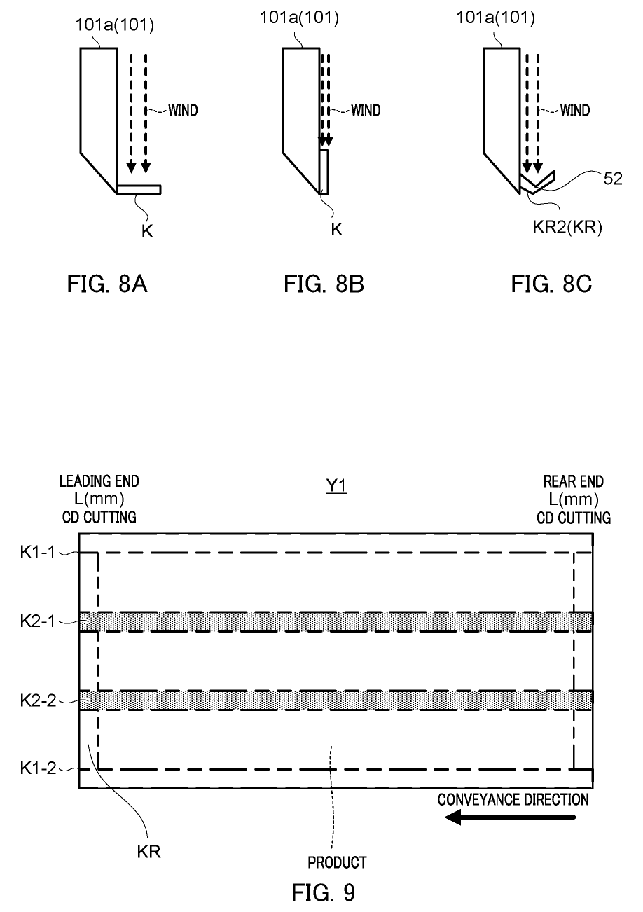

FIG. 8A, FIGS. 8B, and FIG. 8C are diagrams illustrating examples of cutting waste to which wind is blown, FIG. 8A is a diagram illustrating a state in which cutting waste K in the related art after cutting falls by wind blowing, and FIG. 8B is a diagram illustrating a state in which the cutting waste K adheres to the upper blade 101a after cutting. FIG. 8C is a diagram illustrating a state in which wind is blown to cutting waste KR deformed according to the present embodiment.

As illustrated in FIG. 8A, in an apparatus in the related art, the cutting waste K generated after cutting is caused to fall downward by blowing wind from above, but there is a case where the cutting waste K does not fall and, as illustrated in FIG. 8B, sticks to the upper blade 101a in motion. On the other hand, for example, in a case where the image forming apparatus 1 forms the cutting waste KR2 including the fold 52 as the deformed cutting waste (see FIG. 6B), the cutting waste KR2 in its entirety has a bent shape, and the fold becomes air resistance.

Thus, as illustrated in FIG. 8C, even in a case where the cutting waste KR2 is about to stick to the upper blade 101a due to the static electricity with which the cutting waste KR2 is charged, the cutting waste KR2 receives wind blown from above at the fold 52 and easily falls. Note that, even when the perforation 51 or the notch portion 53 is formed in cutting waste, each thereof becomes air resistance when wind is blown thereto, and the cutting waste is likely to easily fall.

In addition, since the perforation 51, the fold 52, or the notch portion 53 is formed, cutting waste is less likely to stick to the upper blade 101a and is likely to fall. As described above, even cutting waste is generated in a thin sheet or is small, the cutting waste can be caused to easily fall, and it is possible to prevent a jam from occurring due to the cutting waste remaining in the conveyance route.

### Cutting Example 1

Here, an example of a sheet on which cutting waste is generated when a product is formed in the image forming apparatus 1 will be described.

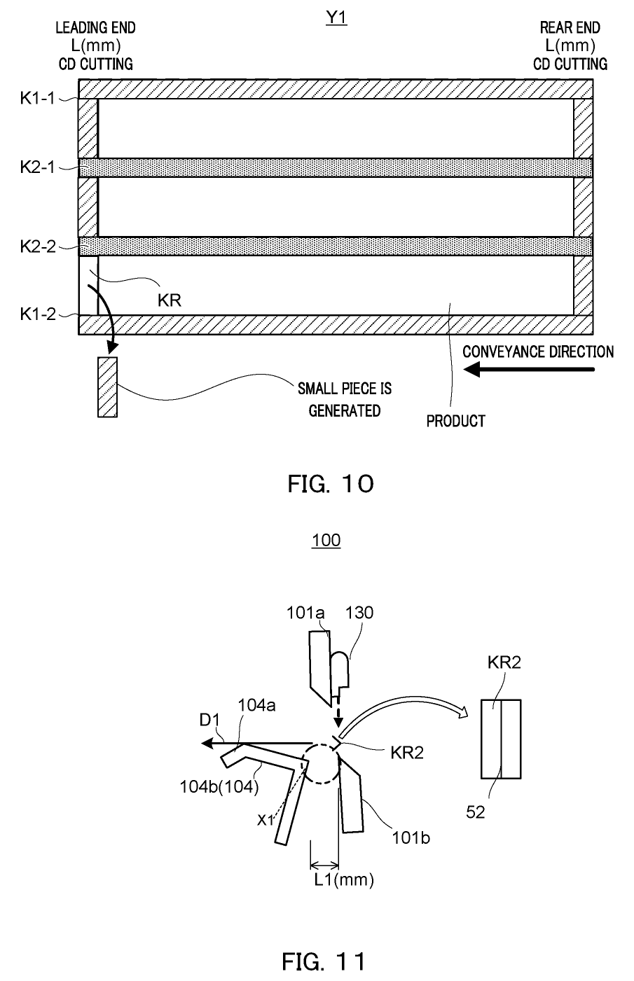

FIG. 9 is a plan view of an exemplary product in which cutting waste is generated, and FIG. 10 is a plan view of the exemplary product in FIG. 9 in a state in which a small piece that is cutting waste is generated.

In the image forming apparatus 1, for example, it is assumed that an image is formed on the sheet Y1 and cutting processing is performed at the cutter 26 to form three products extending in the conveyance direction as illustrated in FIGS. 9 and 10.

A sheet (the sheet Y1 illustrated in FIG. 9) that is conveyed from the image forming apparatus main body 10 is conveyed to the image forming apparatus 1 illustrated in FIG. 1. At the cutter 26, the first FD cutter 26a in the slot 261 cuts portions of slits K1-1 and K1-2 in the sheet Y1 to form the slits K1-1 and K1-2. In addition, the second FD cutter 26b in the slot 262 cuts portions of bleed slits K2-1 and K2-2 to form the bleed slits K2-1 and K2-2.

Next, at the cutter 26, the sheet processor 26c in the slot 263 processes a region which is partitioned by a length L (mm) of a leading end of the sheet Y1 and the length L (mm) of a rear end of the sheet Y1 and becomes cutting waste KR which is a small piece. For example, it is assumed that the sheet processor 26c forms the cutting waste KR2 which is deformed and includes the fold 52 (see FIGS. 8C and 11).

For example, the length L (mm) of the cutting portion at the leading end is smaller than a length L1 of the route X1 in the FD direction (see FIG. 11) through which cutting waste generated by cutting by the CD cutter 100 can fall. Note that, cutting is performed so that the length of the cutting portion at the rear end is smaller than the length of the route X2 in the FD direction in the same manner as that of the route X1.

FIG. 11 is a diagram illustrating a state in which cutting waste is generated by a cutter in the image forming apparatus. Note that, FIG. 11 is a schematic side view of the cutting waste KR2 with a plan view of the cutting waste KR2.

Thus, when the sheet Y1 is CD cut at the CD cutter 100 illustrated in FIG. 11 and cutting waste KR2 that is a small piece is generated, wind is blown to the cutting waste KR2 by the air blower 130 and the cutting waste KR2 suitably falls into the route X1 without sticking to the upper blade 101a.

### Cutting Example 2

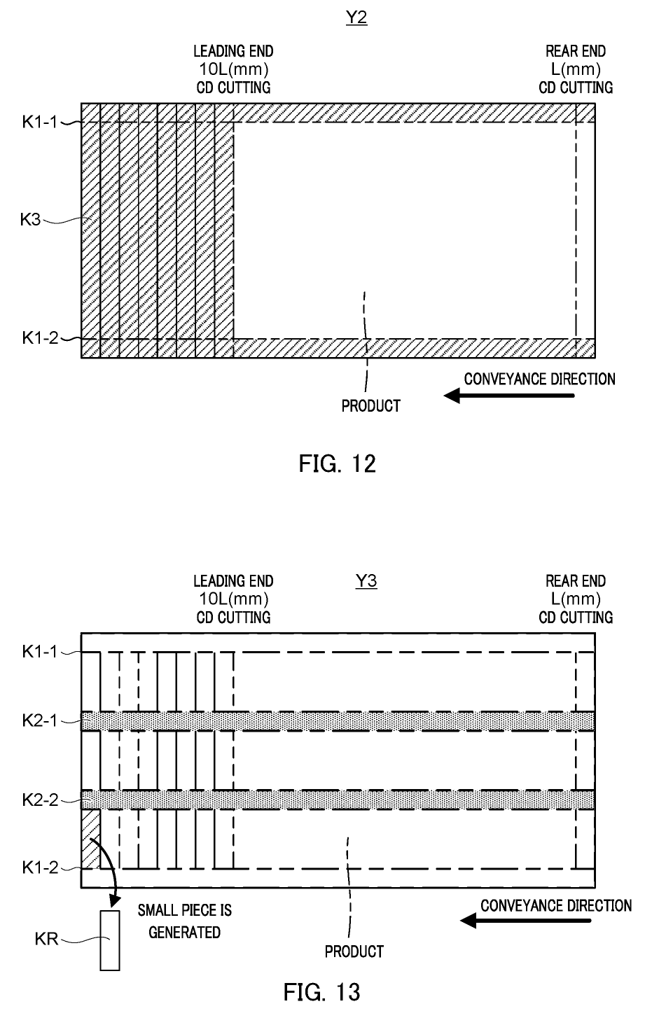

FIG. 12 is a plan view of an exemplary product in which cutting waste is generated.

As illustrated in FIG. 12, when a product is formed by cutting a sheet shorter than a sheet Y2 by a length 10 L (mm) in the FD direction, by a length L (mm) of the rear end, and by the length L (mm) on the both sides, CD cutting is performed for each length L so that a cutting portion K3 in the FD direction passes through the route X1. In a case where this product is formed, cutting waste which is a small piece is not generated, and thus, the sheet processor 26c may not be used.

### Cutting Example 3

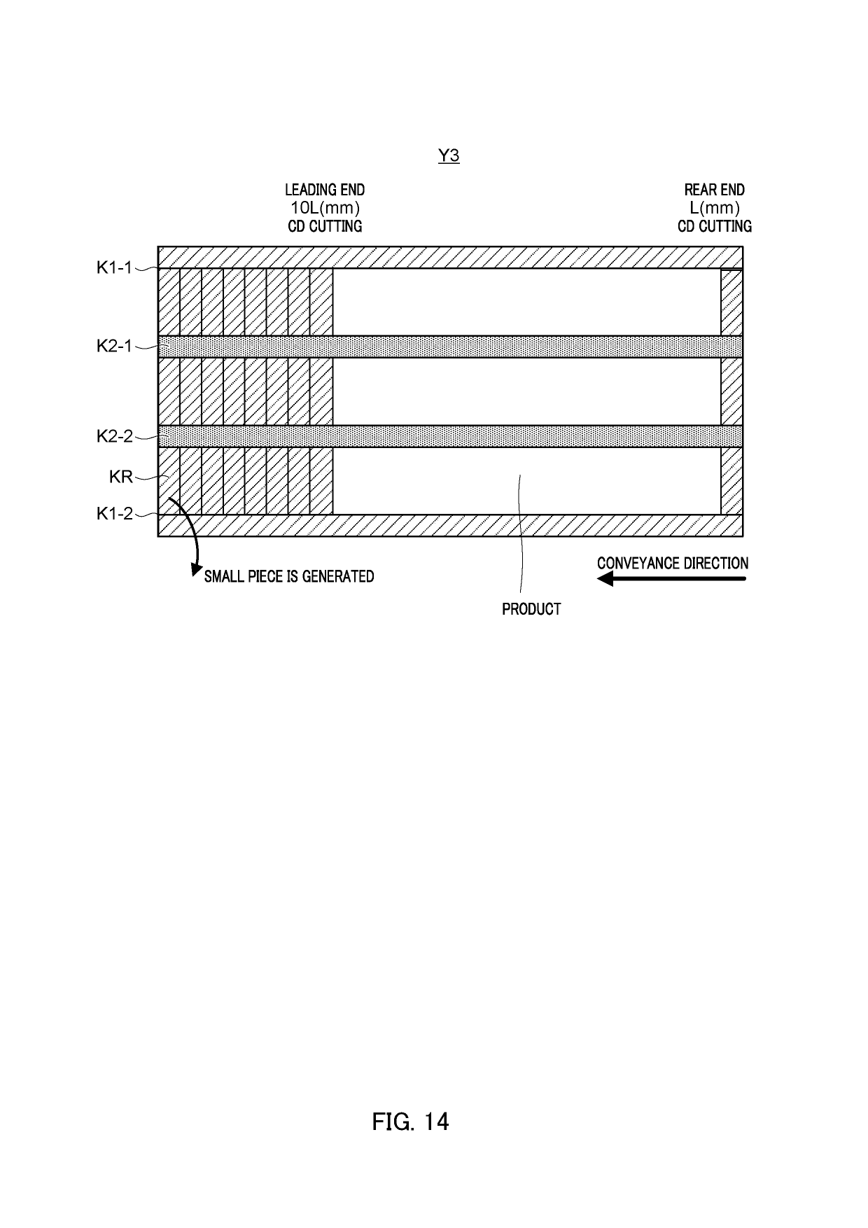

FIG. 13 is a plan view of an exemplary sheet including a product in which cutting waste is generated, and FIG. 14 is a plan view of a cutting waste portion and a product in the sheet illustrated in FIG. 13.

When a sheet Y3 illustrated in FIG. 13 is processed, the cutter 26 of the image forming apparatus 1 cuts slits K1-1 and K-2 with the first FD cutter 26a, and cuts bleed slits K2-1 and K2-2 with the second FD cutter 26b.

Then, at the sheet processor 26c, deformation processing of perforation formation, crease formation, or notch formation is performed for each region, which becomes cutting waste (small piece) KR, for each length L (mm) from the leading end. Here, three locations in the CD direction are continuously deformed a plurality of times (here, 10 times) in the FD direction.

Thereafter, the CD cutter 100 continuously performs CD cutting on the portion having the length L in the FD direction ten times. Thus, the product illustrated in FIG. 14 can be formed. As described above, in the image forming apparatus 1, in order to cause the cutting waste KR to easily fall, a portion of the sheet Y3, where the portion becomes the cutting waste KR, is processed before cutting, thereby making it easy for the waste at the time of cutting to fall.

It should be understood that the embodiment disclosed herein is illustrative and non-restrictive in every respect. The scope of the present invention is defined not by the above description but by the appended claims, and is intended to include any modifications within the scope and meaning equivalent to the appended claims.

Hereinabove, an embodiment of the present invention has been described. Note that, the above description is an exemplification of a preferred embodiment of the present invention, and the scope of the present invention is not limited thereto. That is, the descriptions of the configuration of the apparatus and the shape of each section described above are examples, and it is obvious that various modifications and additions can be made to these examples within the scope of the present invention.

Although embodiments of the present invention have been described and illustrated in detail, the disclosed embodiments are made for purpose of illustration and example only and not limitation. The scope of the present invention should be interpreted by terms of the appended claims.

What is claimed is:

1. A post-processing apparatus, comprising:
a cutter that cuts a sheet in a direction orthogonal to a conveyance direction to generate waste, the sheet being a sheet to be conveyed; and
a sheet processor that is capable of processing the sheet to be conveyed and processes and deforms a region in the sheet, the region becoming the waste after being cut by the cutter.

2. The post-processing apparatus according to claim 1, further comprising an air blower that blows wind from above toward a cutting position of the cutter to promote falling of the waste generated at the cutting position.

3. The post-processing apparatus according to claim 1, wherein
the sheet processor forms a perforation or a crease in the region.

4. The post-processing apparatus according to claim 1, wherein
the sheet processor processes the region based on at least one of a basis weight of the sheet and/or a sheet thickness of the sheet.

5. The post-processing apparatus according to claim 4, wherein
the sheet processor processes the region in a case where the basis weight of the sheet or the sheet thickness of the sheet is smaller than a predetermined value.

6. The post-processing apparatus according to claim 3, wherein
the sheet processor forms the perforation or the crease in the region before the cutter cuts the sheet.

7. The post-processing apparatus according to claim 6, wherein
the sheet processor processes the region so that the perforation or the crease extends in the direction orthogonal to the conveyance direction or in the conveyance direction.

8. The post-processing apparatus according to claim 7, wherein
the cutter continuously cuts the sheet a plurality of times at a predetermined interval from a leading end portion of the sheet in the conveyance direction to generate a plurality of the wastes, the plurality of wastes being a plurality of continuous wastes, and
the predetermined interval is smaller than a length of a route in the conveyance direction, the route being a route through which the plurality of wastes falls.

9. The post-processing apparatus according to claim 6, wherein
the sheet processor processes the region so that the perforation or the crease passes through a center of the region, the region becoming the waste.

10. The post-processing apparatus according to claim 2, wherein
the air blower is a fan that blows wind in a direction perpendicular to an upper surface of the sheet.

11. The post-processing apparatus according to claim 10, wherein
the fan is of a type having a high static pressure.

12. The post-processing apparatus according to claim 10, wherein
the fan is driven at a timing when the sheet is cut.

13. An image forming apparatus, comprising:
the post-processing apparatus according to claim 1; and
an image forming apparatus main body that forms an image on the sheet and ejects, to the post-processing apparatus, the sheet on which the image has been formed.
